(19) United States
(12) Patent Application Publication
(10) Pub. No.: US 2008/0192334 A1
(43) Pub. Date: Aug. 14, 2008

(54) Objective System for an Optical Scanning Device for Ultraviolet and/or Deep-Ultraviolet Wavelengths

(75) Inventors: Jacobus Hermanus Maris Neijzen, Eindhoven (NL); Helmar Van Santen, Amsterdam (NL); Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,713

(22) PCT Filed: Apr. 28, 2006
(86) PCT No.: PCT/IB2006/051342

§ 371 Date: Nov. 6, 2007

(30) Foreign Application Priority Data
May 11, 2005 (EP) 05103907.1

(51) Int. Cl. G02B 13/14; G02B 1/00

(52) U.S. Cl. 359/355

(57) ABSTRACT

An objective system (1″) for an optical scanning device for ultraviolet and/or deep-ultraviolet wavelengths is provided. The objective system (1″) comprises at least one glass component (3″) with an aspherical surface. The at least one glass component (3″) is made of a glass material comprising a low softening temperature and a low absorption coefficient for ultraviolet and/or deep-ultraviolet wavelengths.

The present invention relates to an objective system for an optical scanning device for ultraviolet and/or deep-ultraviolet wavelengths and such an optical scanning device.

Optical components for ultraviolet and/or deep-ultraviolet wavelength ray regions especially for objective systems are usually made of fused silica because of the high UV absorption in glass materials. The fact that the choice of optical materials in this wavelength region is almost exclusively limited to quartz has various disadvantages, especially for components with a high numerical aperture. The option of using quartz with non-spherical or aspherical surfaces is not attractive, as the glass moulding of quartz glass requires extremely high temperatures. This results in a high price for a moulded component with an aspherical surface. The alternative of using spherical surfaces only leads to optical components or objective systems with a large number of elements. For this reason, the size and the weight of such optical components or objective systems increases significantly. In actuated components like objective systems or lenses for ultraviolet and/or deep-ultraviolet wavelengths in mastering and recording systems the weight is essential. If semiconductor lasers in the ultraviolet and/or deep-ultraviolet wavelength ray region become available, an application in the area of ultraviolet optical recording is only possible if cheap objective lenses can be provided.

A lens device for focusing a beam of an ultraviolet-ray region, provided with at least one aspherical lens made of synthetic quartz in which an aspherical portion is formed by coating a fluororesin on a spherical portion of a side polished to spherical surface is known from U.S. Pat. No. 5,852,508.

It is an object of the present invention to provide an objective system for an optical scanning device for ultraviolet and/or deep-ultraviolet wavelengths and such an optical scanning device comprising a reduced size and weight while keeping the manufacturing costs low.

In a first aspect, the present invention provides an objective system for an optical scanning device for ultraviolet and/or deep-ultraviolet wavelengths, the objective system comprising at least one glass component with an aspherical surface, wherein the at least one glass component is made of a glass material comprising a low softening temperature and a low absorption coefficient for ultraviolet and/or deep-ultraviolet wavelengths.

This allows the use of aspherical surfaces in the moulded soft glass component, while the absorption can be kept at an acceptable level by limiting the thickness of the glass component. Thus an optical component or an objective system is provided with a moulded aspherical surface suited for ultraviolet and/or deep-ultraviolet wavelengths having a reduced size and a reduced weight for relatively low prices. A single aspherical soft glass component can be used as long as the lens is small (e.g. 1-2 mm).

In a preferred embodiment of the invention, the objective system further comprises at least one optical component with a spherical surface.

Such an objective system provides a combination of a soft glass component with other spherical optical elements, i.e. optical components with spherical surfaces.

In a preferred embodiment of the invention, the softening temperature of the glass material is below 700° C., more preferably below 600° C. Therefore the soft glass component is mouldable using relatively low temperatures.

In a further embodiment of the invention, the absorption of the glass material at a wavelength of 257 nm is less than 25% more preferably less than 18% for 1 mm thickness along the optical axis of the glass component.

In a preferred embodiment of the invention, the glass material is an ultra-pure sodium lime or sodium barium glass and/or comprises a low concentration of contaminating metal components, e.g. a concentration of Fe₃O₂ equivalent components which is less than 15 mg per kg. Such a glass material comprises a high transmission e.g. at a 257 nm wavelength and a relatively low softening temperature (e.g. 670° C.). The high transmission among other things results from a low concentration of contaminating metal components, i.e. from the purity of the glass material. The presence of Fe (especially in trivalent Fe³⁺ form), Ti and Pb contaminations is reduced in this material. The melting point and the softening point is much lower than of fused silica.

In a further embodiment of the invention, the at least one glass component is made with a glass moulding technique. This can be made in an easy and inexpensive way, as lower temperatures are required.

In a further embodiment of the invention, the at least one glass component and the at least one optical component with a spherical surface are either integrated into a single component or are separate components.

In a further embodiment of the invention, the at least one optical component with a spherical surface is made of fused silica.

In a preferred embodiment of the invention, the objective system comprises a first and a second optical component with a spherical surface and one glass component with an aspherical surface, wherein said glass component comprises a flat side and wherein said flat side of said glass component is mounted to a flat side of said first optical component with a spherical surface.

In a second aspect, the present invention provides an optical scanning device for ultraviolet and/or deep-ultraviolet wavelengths comprising the above described objective system according to the invention.

In a third aspect, the present invention provides an optical scanning device for ultraviolet and/or deep-ultraviolet wavelengths for scanning an information layer of an optical record carrier, the device comprising a radiation source for generating a radiation beam of ultraviolet and/or deep-ultraviolet wavelengths and the above described objective system according to the invention for converging the radiation beam on the information layer.

These and other aspects of the invention are apparent from and will be elucidated by way of example with reference to the embodiments described hereinafter and illustrated in the accompanying drawings. In the drawings:

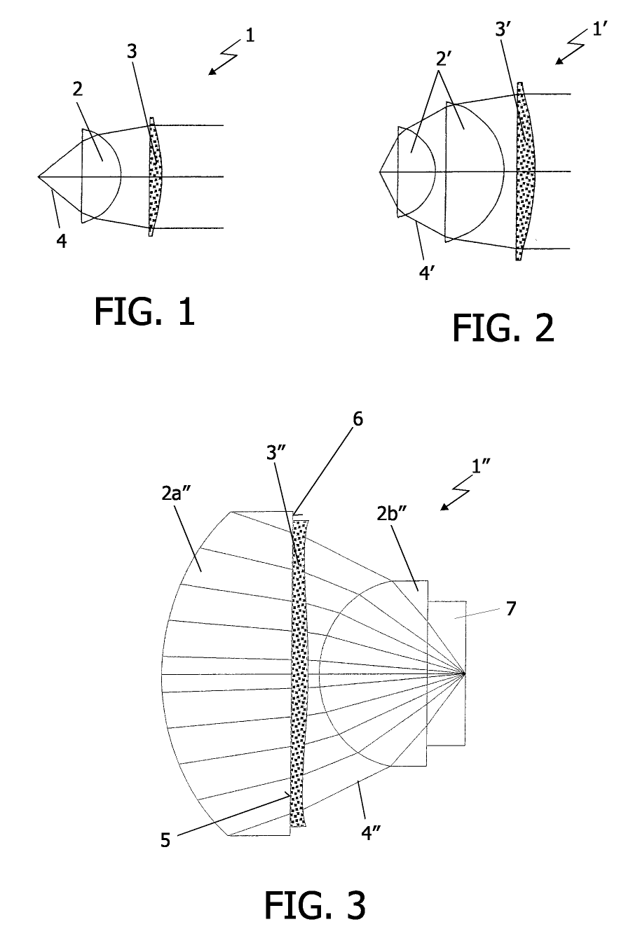

FIG. 1 shows a schematic illustration of first embodiment of an objective system according to the invention;

FIG. 2 shows a schematic illustration of a second embodiment of an objective system according to the invention;

FIG. 3 shows a schematic illustration of a third embodiment of an objective system according to the invention; and

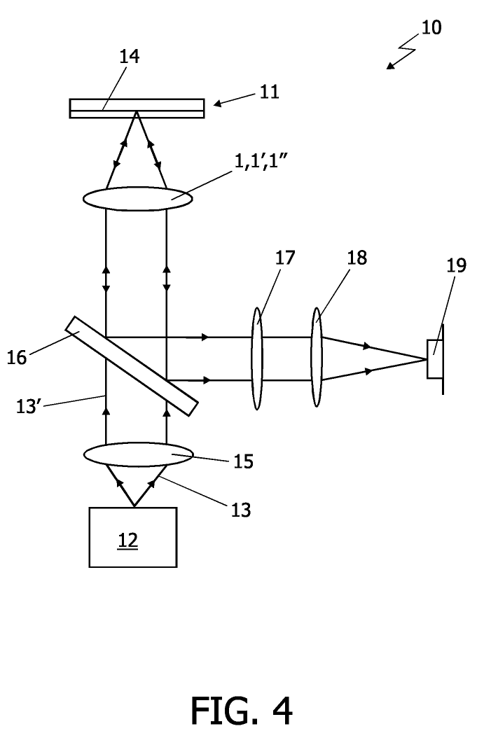

FIG. 4 shows a schematic illustration of an optical scanning device according to the invention.

FIG. 1 shows an objective system or lens 1 with a relatively low numerical aperture (NA=0.6) according to the present invention. The objective system 1 is suitable for an optical scanning device for ultraviolet and/or deep-ultraviolet wavelengths. The objective system 1 comprises a spherical component 2, i.e. an optical component with a spherical surface and a glass component 3 with an aspherical surface. The thin glass component 3 is made of a glass material comprising a relatively low softening temperature of 670° C. and a low absorption coefficient for ultraviolet and/or deep-ultraviolet wavelengths, i.e. less than 18% for 1 mm thickness along the optical axis of the glass component 3 (at a wavelength of 257 nm). The glass material of the glass component 3 is an ultra-pure sodium barium glass. In another embodiment of the invention it could also be an ultra-pure sodium lime glass. The glass material comprises a low concentration of contaminating metal components, e.g. a concentration of Fe₃O₂ equivalent components which is less than 15 mg per kg. The high transmission among other things results from this low concentration of contaminating metal components, i.e. from the purity of the glass material. The presence of Fe (especially in trivalent Fe³⁺ form), Ti and Pb contaminations is reduced in this material. The glass component 3 is made with a glass moulding technique. This can be made in an easy and cheap way, as only lower temperatures are required. The glass component 3 and the spherical component 2 are separate components. The spherical component 2 is made of fused silica. In further embodiments also other materials (e.g. CaF₂) could be used. In FIGS. 1 to 3 reference sign 4, 4′ and 4″ indicate the respective radiation beam used for scanning.

FIG. 2 shows a second embodiment of an objective system 1′ according to the invention with a relatively high numerical aperture comprising two spherical components 2′ of fused silica as a doublet and a moulded soft glass component 3′ as correction plate.

FIG. 3 shows a third embodiment of an objective system 1″ as a deep-ultraviolet water immersion objective lens. The objective system 1″ comprises a first and a second truncated optical component 2a″, 2b″ of fused silica having refractive index of 1.504 and a glass component 3″ with an aspherical surface having refractive index of 1.565. The plano-spherical optical component 2a″ has a thickness of 1.527 mm along the optical axis and a radius of 2.431 mm, while the plano-spherical component 2b″ has a thickness of 1.285 mm along the optical axis and radius of 1.044 mm. The glass component 3″ with an aspherical surface has thickness 0.2 mm along the optical axis, wherein said glass component 3″ comprises a flat side 5 and wherein said flat side 5 of said thin glass component 3″ is mounted to a flat side 6 of said first truncated optical component 2a″ with a spherical surface, i.e. the components 2a″, 3″ are integrated into a single component. The air gap between component 3″ and 2b″ has thickness of 0.128 mm along the optical axis. The glass component 3″ is a plate which allows the material to be rather thin resulting in only a small power loss. The rotational symmetric aspherical surface of the glass component 3″ is given by the equation

$$z ( r ) = {\sum }_{i = 1}^{8} {B}_{2 i} {r}^{2 i}$$

with z the position of the surface in the direction of the optical axis in millimeters, r the distance to the optical axis in millimeters and Bₖ the coefficient of the k-th power of r. The values of the coefficients B₂ to B₁₆ are −0.06960321, 0.025506074, −0.0051217592, 0.0045984153, −0.004201516, 0.0024679092, −0.00076736507 and 0.000099049314, respectively. The numerical aperture of the objective system 1″ is NA=1.1 based on water immersion. In the present embodiment the entrance pupil is 3.6 mm and the wavelength used is 257.2 nm. The water layer 7 has thickness of 0.45 mm and has refractive index 1.394. The tolerance for decentering of the aspherical glass component 3″ giving rise to coma, is limited. During assembly of the objective system 1″, this can easily be compensated for by tilting the second truncated spherical optical component 2b″ with respect to the first truncated spherical optical component 2a″.

FIG. 4 shows an optical scanning device 10 capable of scanning optical record carriers 11. The optical scanning device 10 comprises a radiation source 12 in form of a semiconductor laser (not shown in detail), which emits a radiation beam 13 in an ultraviolet (i.e. <350 nm) and/or deep-ultraviolet wavelength (i.e. between 150 and 300 nm) corresponding to the optical record carrier 11 which is to be read. The radiation beam 13 is used for scanning an information layer 14 of the optical record carrier 11. The radiation beam 13 emitted by the radiation source 12 enters a collimator lens 15. The collimator lens 15 converts the beam 13 into a collimated beam 13′, which leads through a beam splitter 16. The beam splitter 16 transmits the beam towards the objective system 1,1′,1″ according to the invention which focuses the beam 13′ onto the optical record carrier 11. The converging beam 13′ passing through the objective system 1,1′,1″, impinges on an entrance face of the record carrier 11 and forms a spot on the information layer 14. Radiation reflected by the information layer 14 forms a diverging beam, transformed into a substantially collimated beam by the objective system 1,1′,1″ and goes to the beam splitter 16. The beam splitter 16 separates the forward and reflected beams by reflecting at least a part of the collimated beam towards a servo lens 17. Then the beam goes through a cylinder lens 18 towards a detection system 19. The detection system 19 captures the radiation and converts it into electrical output signals, which are processed by signal processing circuits, located in the optical scanning device 10 separately from the optical head. A signal processor converts these output signals to various other signals (not shown).

Although the invention was described on the basis of an optical scanning device for scanning an information layer of an optical record carrier, the objective system according to the invention can also be used in other optical systems for ultraviolet and/or deep-ultraviolet wavelengths, such as devices for optical recording, optical mastering machines and optical scanning microscopes (scanning fluorescence microscopy or confocal microscopy).

1. An objective system (1,1′,1″) for an optical scanning device (10) for ultraviolet and/or deep-ultraviolet wavelengths, the objective system (1,1′,1″) comprising at least one glass component (3,3′,3″) with an aspherical surface, wherein the at least one glass component (3,3′,3″) is made of a glass material comprising a low softening temperature and a low absorption coefficient for ultraviolet and/or deep-ultraviolet wavelengths.

2. An objective system as claimed in claim 1, further comprising at least one optical component (2,2′,2a″,2b″) with a spherical surface.

3. An objective system as claimed in claim 1, wherein the softening temperature of the glass material is below 700° C.

4. An objective system as claimed in claim 1, wherein the softening temperature of the glass material is below 600° C.

5. An objective system as claimed in claim 1, wherein the absorption of the glass material at a wavelength of 257 nm is less than 25% for 1 mm thickness along the optical axis of the glass component (3,3′,3″).

6. An objective system as claimed in claim 1, wherein the absorption of the glass material at a wavelength of 257 nm is less than 18% for 1 mm thickness along the optical axis of the glass component (3,3′,3″).

7. An objective system as claimed in claim 1, wherein the glass material is an ultra-pure sodium lime or sodium barium glass.

8. An objective system as claimed in claim 1, wherein the glass material comprises a low concentration of contaminating metal components.

9. An objective system as claimed in claim 8, wherein the concentration of Fe₃O₂ equivalent components is less than 15 mg per kg.

10. An objective system as claimed in claim 1, wherein the at least one glass component (3,3′,3″) is made with a glass moulding technique.

11. An objective system as claimed in claim 2, wherein the at least one glass component (3″) and the at least one optical component (2a″) with a spherical surface are integrated into a single component.

12. An objective system as claimed 2 , wherein the at least one optical component (3,3′,3″) with a spherical surface is made of fused silica.

13. An objective system as claimed in claim 2, comprising a first (2a″) and a second (2b″) optical component with a spherical surface and one glass component (3″) with an aspherical surface.

14. An objective system as claimed in claim 13, wherein said glass component (3″) comprises a flat side (5) and wherein said flat side (5) of said glass component (3″) is mounted to a flat side (6) of said first optical component (2a″) with a spherical surface.

15. An optical scanning device (10) for ultraviolet and/or deep-ultraviolet wavelengths comprising an objective system (1,1′,1″) as claimed in claim 1.
